(19) United States
(12) Patent Application Publication
(10) Pub. No.: US 2016/0115061 A1
(43) Pub. Date: Apr. 28, 2016

(54) WATER TREATMENT SYSTEM, WATER TREATMENT METHOD, COOLING FACILITY AND POWER GENERATING FACILITY

(71) Applicant: MITSUBISHI HEAVY INDUSTRIES, LTD., Tokyo (JP)

(72) Inventors: Nobuyuki Ukai, Tokyo (JP); Susumu Okino, Tokyo (JP); Masayuki Eda, Tokyo (JP); Hideo Suzuki, Tokyo (JP); Hiroshi Nakashoji, Tokyo (JP); Shigeru Yoshioka, Tokyo (JP)

(73) Assignee: MITSUBISHI HEAVY INDUSTRIES, LTD., Tokyo (JP)

(21) Appl. No.: 14/787,074

(22) PCT Filed: Jul. 4, 2014
(86) PCT No.: PCT/JP2014/067957

§ 371 Date: Oct. 26, 2015

(30) Foreign Application Priority Data
Jul. 5, 2013 (JP) 2013-142121

(51) Int. Cl. C02F 9/00

(52) U.S. Cl. CPC C02F 9/00; C02F 1/66

(57) ABSTRACT

A water treatment system provided with: a first scale inhibitor-supplying unit which supplies a scale inhibitor to a blowdown water, the blowdown water being water to be treated that is generated in a cooling tower and contains at least a salt and silica; a first pH-adjusting unit which adjusts the pH of the blowdown water, to which the scale inhibitor has been supplied using a pH adjusting agent; a first desalinating apparatus which is provided downstream of the first pH-adjusting unit, removes the salt in the blowdown water, and separates the water into a first reclaimed water and a first concentrated water; and a first crystallizing unit which is provided downstream of the first desalinating apparatus and has a first crystallizing tank for calcium sulfate from the first concentrated water and a first seed crystal-supplying unit for supplying calcium sulfate seed crystals of calcium sulfate to the first crystallizing tank.

### TECHNICAL FIELD

The present invention relates to a water treatment system and method for, for example, cooling tower blowdown water or the like, a cooling facility, and a power generating facility.

### BACKGROUND ART

In a cooling tower used at a plant facility or the like, heat exchange is performed between cooling water and high-temperature exhaust gas discharged from a boiler or the like. A portion of the cooling water becomes steam due to this heat exchange, so the ions or silica (SiO₂) in the cooling water are concentrated. Accordingly, the cooling water discharged from the cooling tower (blowdown water) reaches a state with a high ion concentration or silica concentration.

Water containing large quantities of ions is released into the environment after being desalinated. Known examples of apparatuses for performing desalination treatment include a reverse osmosis membrane apparatus, a nanofiltration membrane apparatus, and an ion exchange membrane apparatus.

Of the ions contained in the water described above, monovalent positive ions such as Na⁺, K⁺, and NH₄⁺ or negative ions such as Cl⁻ and NO₃⁻ are ions with high solubility in water. On the other hand, divalent metal ions such as Ca²⁺, negative ions such as SO₄²⁻ and CO₃²⁻, or silica are components constituting scale. Since salts or silica serving as components constituting scale have low solubility with respect to water, they are easily deposited as scale. In particular, Ca²⁺, SO₄²⁻, and carbonate ions (CO₃²⁻ and HCO₃⁻), and silica are contained in abundance in brine, industrial waste water, and blowdown water of cooling towers. When scale is generated inside the apparatus for performing the desalination treatment described above, the treatment capacity is diminished. Therefore, there is a demand to perform desalination treatment without generating scale.

The lime-soda method is known as a method for removing Ca²⁺. In the lime-soda method, sodium carbonate is added to water to be treated, and the Ca²⁺ in the water to be treated precipitates and settles as calcium carbonate and thereby removed from the water.

Patent Document 1 discloses a waste water treatment apparatus that uses the lime-soda method in which a chemical softening apparatus, an ion exchange apparatus, a reverse osmosis membrane apparatus, and the like are combined.

### CITATION LIST

### Patent Literature(s)

Patent Document 1: U.S. Pat. No. 7,815,804B

### SUMMARY OF INVENTION

### Technical Problem

The lime-soda method involves a high treatment cost since it requires the addition of sodium carbonate for the purpose of treatment. With the lime-soda method, when 1 mol of Ca²⁺ is deposited as calcium carbonate, 2 mol of Na⁺ is generated. On the other hand, when SO₄²⁻ is contained in water to be treated, it is not removed by the lime-soda method. That is, the lime-soda method results in an increase in the number of moles of ions contained in the water after treatment.

Even when Ca²⁺ is removed using an ion exchange membrane apparatus, 2 mol of Na⁺ is generated in order to treat 1 mol of Ca²⁺, and the number of moles of ions contained in the water after treatment increases.

In the system of Patent Document 1, water that has been treated by the lime-soda method and an ion exchange membrane apparatus is further treated to remove the ion content with a reverse osmosis membrane apparatus. Therefore, in the system of Patent Document 1, the molar concentration of ions increases, so the osmotic pressure in the reverse osmosis membrane apparatus becomes high, which leads to the problem that the treatment load becomes large. In addition, with the apparatus of Patent Document 1, SO₄²⁻ is not removed, and SO₄²⁻ remains in the treatment water, which makes it difficult to achieve a high water recovery ratio. Furthermore, the waste water treatment apparatus of Patent Document 1 also requires large quantities of chemicals when regenerating the ion exchange apparatus, and the high treatment cost is problematic.

In light of the problems described above, an object of the present invention is to provide a water treatment system and method for, for example, water to be treated that contains at least a salt and silica such as cooling tower blowdown water from a cooling tower used in a plant facility or the like, and a cooling facility and a power generating facility.

### Solution to Problem

A first invention of the present invention for solving the above problems is a water treatment system comprising: a first scale inhibitor-supplying unit, which supplies a scale inhibitor to water to be treated that contains at least a salt and silica; a first pH-adjusting unit, which adjusts a pH of the water to be treated to which the scale inhibitor has been supplied using a pH-adjusting agent; a first desalinating apparatus, which is provided downstream of the first pH-adjusting unit and removes salts in the water to be treated and separates the water into first reclaimed water and first concentrated water; and a first crystallizing unit which, has a first crystallizing tank, which is provided downstream of the first desalinating apparatus and crystallizes calcium sulfate from the first concentrated water, and a first seed crystal-supplying unit which, supplies seed crystals of calcium sulfate to the first crystallizing tank.

A second invention is a water treatment system comprising: a first scale inhibitor-supplying unit, which supplies a scale inhibitor to water to be treated that contains at least a salt and silica; a first pH-adjusting unit, which adjusts a pH of the water to be treated to which the scale inhibitor has been supplied using a pH-adjusting agent; a first desalinating apparatus, which is provided downstream of the first pH-adjusting unit and removes salts in the water to be treated and separates the water into first reclaimed water and first concentrated water; a first crystallizing unit, which has a first crystallizing tank, which is provided downstream of the first desalinating apparatus and crystallizes calcium sulfate from the first concentrated water, and a first seed crystal-supplying unit, which supplies seed crystals of calcium sulfate to the first crystallizing tank; a first separating unit, which is provided downstream of the first crystallizing unit and separates calcium sulfate in the first concentrated water; a second scale inhibitor-supplying unit, which supplies a scale inhibitor to the first concentrated water from which calcium sulfate has been separated; a second pH-adjusting unit, which adjusts a pH of the first concentrated water to which the scale inhibitor has been supplied; and a second desalinating apparatus, which is provided downstream of the second pH-adjusting unit and removes salts in the first concentrated water and separates the water into second reclaimed water and second concentrated water.

A third invention is the water treatment system according to the second invention, further comprising: a second crystallizing unit, which has a second crystallizing tank, which is provided downstream of the second desalinating apparatus and crystallizes calcium sulfate from the second concentrated water, and has a second seed crystal-supplying unit, which supplies seed crystals of calcium sulfate to the second crystallizing tank.

A fourth invention is the water treatment system according to the second invention, further comprising: a second crystallizing unit, which has a second crystallizing tank, which is provided downstream of the second desalinating apparatus and crystallizes calcium sulfate from the second concentrated water, and a second seed crystal-supplying unit, which supplies seed crystals of calcium sulfate to the second crystallizing tank; a second separating unit, which is provided downstream of the second crystallizing unit and separates calcium sulfate in the second concentrated water; and a third desalinating apparatus, which removes salts in the second concentrated water and separates the water into third reclaimed water and third concentrated water.

A fifth invention is the water treatment system according to the first or second invention, wherein, when the pH is adjusted to not less than 10 by the first pH-adjusting unit or second pH-adjusting unit, calcium scale inhibitor which inhibits deposition of scale containing calcium is supplied from the first or second scale inhibitor-supplying unit.

A sixth invention is the water treatment system according to the first or second invention, wherein, when the pH is adjusted to not greater than 10 by the first pH-adjusting unit or second pH-adjusting unit, calcium scale inhibitor which inhibits deposition of scale containing calcium and silica scale inhibitor which inhibits deposition of silica are supplied from the scale inhibitor-supplying unit.

A seventh invention is the water treatment system according to the first or second invention, further comprising: one or both of a settling unit, which decreases a calcium carbonate concentration in the water to be treated; and a carbon dioxide gas separating unit, which separates carbon dioxide gas, provided upstream of the first or second scale inhibitor-supplying unit.

An eighth invention is the water treatment system according to the first or second invention, the reclaimed water being used as makeup water or recycled water of a plant facility.

A ninth invention is a cooling facility comprising the water treatment system described in any one of the first to eighth inventions.

A tenth invention is a power generating facility comprising the cooling facility described in the ninth invention.

An eleventh invention is a water treatment method comprising the steps of: a first scale inhibitor-supplying step, in which a scale inhibitor is supplied to water to be treated that contains at least a salt and silica; a first pH-adjusting step, in which a pH of blowdown water to which the scale inhibitor has been supplied is adjusted using a pH-adjusting agent; a first desalinating step, which is provided downstream of the first pH-adjusting step and in which salts in the blowdown water are removed and the water is separated into first reclaimed water and first concentrated water; a first crystallizing step, which is provided downstream of the first desalinating apparatus and in which calcium sulfate is crystallized from the first concentrated water, and a first seed crystal-supplying step, in which seed crystals of calcium sulfate are supplied in the first crystallizing step.

A twelfth invention is a water treatment method comprising the steps of: a first scale inhibitor-supplying step, in which a scale inhibitor is supplied to water to be treated that contains at least a salt and silica; a first pH-adjusting step, in which a pH of blowdown water to which the scale inhibitor has been supplied is adjusted using a pH-adjusting agent; a first desalinating step, which is provided downstream of the first pH-adjusting step and in which salts in the blowdown water are removed and the water is separated into first reclaimed water and first concentrated water; a first crystallizing step, which is provided downstream of the first desalinating apparatus and in which calcium sulfate is crystallized from the first concentrated water; a first seed crystal-supplying step, in which seed crystals of calcium sulfate are supplied in the first crystallizing step; a first separating step, which is provided downstream of the first crystallizing step, and in which calcium sulfate in the first concentrated water is separated; a second scale inhibitor-supplying step, in which a scale inhibitor is supplied to the first concentrated water from which calcium sulfate has been separated; a second pH-adjusting step, in which a pH of the first concentrated water to which the scale inhibitor has been supplied is adjusted; and a second desalinating step, which is provided downstream of the second pH-adjusting step and in which salts in the first concentrated water are removed and the water is separated into second reclaimed water and second concentrated water.

A thirteenth invention is the water treatment method according to the twelfth invention, further comprising the steps of: a second crystallizing step, which is provided downstream of the second desalinating step and in which calcium sulfate is crystallized from the second concentrated water; and a second seed crystal-supplying step, in which seed crystals of calcium sulfate are supplied to the second crystallizing tank.

A fourteenth invention is the water treatment method according to the twelfth invention, further comprising the steps of: a second crystallizing step, which is provided downstream of the second desalinating step and in which calcium sulfate is crystallized from the second concentrated water; a second seed crystal-supplying step, in which seed crystals of calcium sulfate are supplied to the second crystallizing tank; a second separating step, which is provided downstream of the second crystallizing step, calcium sulfate in the second concentrated water is separated; and a third desalinating step, in which salts in the second concentrated water are removed and the water is separated into third reclaimed water and third concentrated water.

A fifteenth invention is the water treatment method according to the eleventh or twelfth invention, wherein, when the pH is adjusted to not less than 10 by the first or second pH-adjusting step, calcium scale inhibitor which inhibits deposition of scale containing calcium is supplied in the scale inhibitor-supplying step.

A sixteenth invention is the water treatment method according to the eleventh or twelfth invention, wherein, when the pH is adjusted to not greater than 10 by the first or second pH-adjusting step, calcium scale inhibitor which inhibits deposition of scale containing calcium and silica scale inhibitor which inhibits deposition of silica are supplied in the scale inhibitor-supplying step.

A seventeenth invention is the water treatment method according to the eleventh or twelfth invention, further comprising: one or both of a settling step, in which a calcium carbonate concentration in the blowdown water is decreased, and a carbon dioxide gas separating step, in which carbon dioxide gas is separated, provided upstream of the first or second scale inhibitor-supplying step.

An eighteenth invention is the water treatment method according to the eleventh or twelfth invention, wherein the reclaimed water is used as makeup water or recycled water of a plant facility.

### Advantageous Effects of Invention

According to the present invention, water to be treated containing at least a salt and silica, such as cooling tower blowdown water from a cooling tower used in a plant facility or the like can be reclaimed and reused.

### BRIEF DESCRIPTION OF DRAWINGS

FIG. 1 is a schematic view of a cooling tower blowdown water reclamation treatment system pertaining to Embodiment 1.

FIG. 2 is a schematic view of another cooling tower blowdown water reclamation treatment system pertaining to Embodiment 1.

FIG. 3 is a schematic view of another cooling tower blowdown water reclamation treatment system pertaining to Embodiment 1.

FIG. 4 is a schematic view of a cooling tower blowdown water reclamation treatment system pertaining to Embodiment 2.

FIG. 5 is a schematic view of another cooling tower blowdown water reclamation treatment system pertaining to Embodiment 2.

FIG. 6 is a schematic view of a spray dryer pertaining to Embodiment 2.

FIG. 7 illustrates simulation results of pH dependence of the precipitation quantity of calcium sulfate.

FIG. 8 illustrates simulation results of pH dependence of the precipitation quantity of calcium carbonate.

FIG. 9 illustrates simulation results of pH dependence of the precipitation quantity of silica.

FIG. 10 illustrates the results of calcium sulfate precipitation tests performed by varying the pH of simulated water using simulated water in which calcium sulfate is in a supersaturated state.

FIG. 11 illustrates the results of calcium sulfate precipitation tests performed by varying the concentration of seed crystals using simulated water in which calcium sulfate is in a supersaturated state.

FIG. 12 is a microscope photograph of calcium sulfate obtained by crystallization.

FIG. 13 is a microscope photograph of calcium sulfate obtained by crystallization.

FIG. 14 is a schematic view of another cooling tower blowdown water reclamation treatment system.

FIG. 15 is a schematic view of another cooling tower blowdown water reclamation treatment system.

### DESCRIPTION OF EMBODIMENTS

The following is a detailed description of preferred embodiments with reference to the attached drawings. Note that the invention is not limited by the embodiments, and when a plurality of embodiments are present, the invention is intended to include a configuration combining these embodiments.

### Embodiment 1

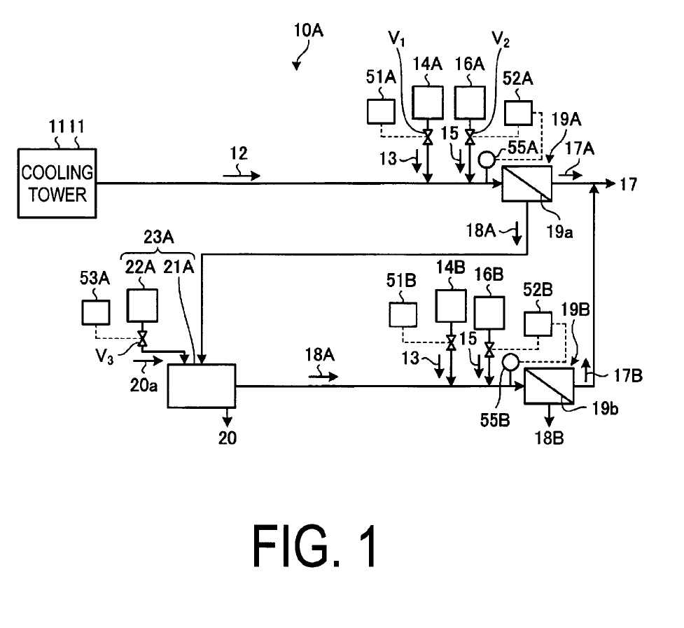

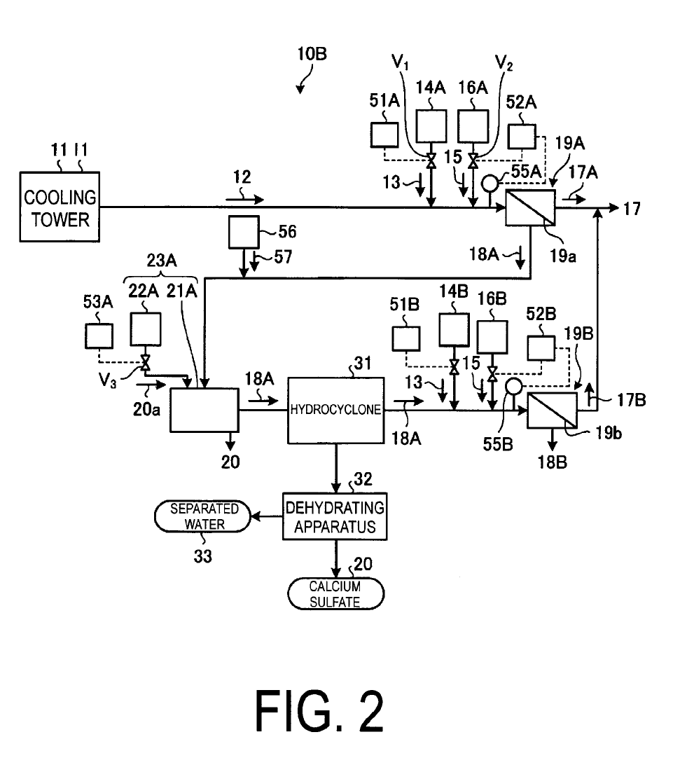

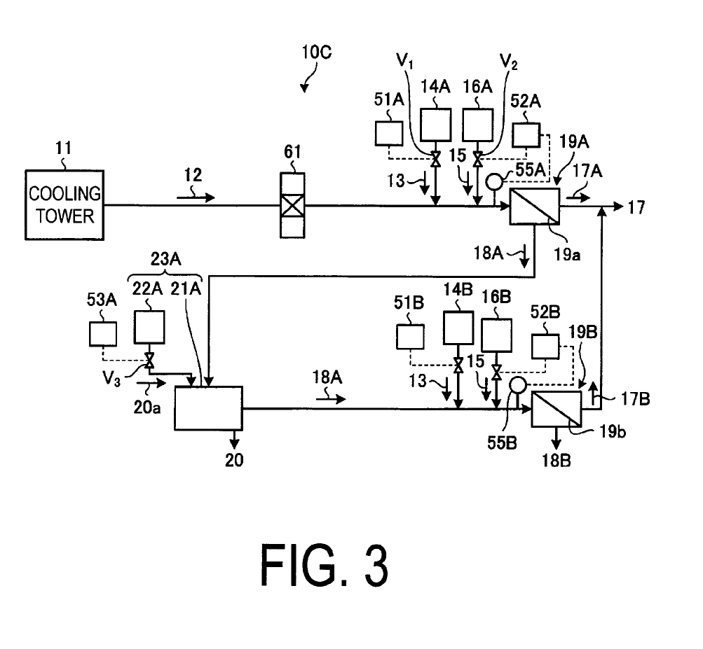

FIG. 1 is a schematic view of a cooling tower blowdown water reclamation treatment system pertaining to Embodiment 1. FIGS. 2 and 3 are schematic views of other cooling tower blowdown water reclamation treatment systems pertaining to Embodiment 1.

As illustrated in FIG. 1, a cooling tower blowdown water reclamation treatment system 10A pertaining to the present embodiment has a first scale inhibitor-supplying unit 14A, which supplies a scale inhibitor 13 to cooling tower blowdown water (“blowdown water” hereinafter), which is water to be treated, that contains at least a salt and silica and is generated by a cooling tower 11; a first pH-adjusting unit 16A, which adjusts a pH of blowdown water 12 to which the scale inhibitor 13 has been supplied using a pH-adjusting agent 15; a first desalinating apparatus 19A, which is provided downstream of the first pH-adjusting unit 16A, removes salts in the blowdown water 12 and separates the water into first reclaimed water 17A and first concentrated water 18A; and a first crystallizing unit 23A, which has a first crystallizing tank 21A which is provided downstream of the first desalinating apparatus 19A and crystallizes calcium sulfate 20 from the first concentrated water 18A, and a first seed crystal-supplying unit 22A which supplies seed crystals of calcium sulfate (calcium sulfate seeds) 20a to the first crystallizing tank 21A.

Here, in FIG. 1, reference numeral 51A indicates a controller of the first scale inhibitor-supplying unit 14A; 52A indicates a controller of the first pH-adjusting unit 16A; 53A indicates a controller of the first seed crystal-supplying unit 22A; and V₁ to V₃ indicate opening and closing valves which are opened and closed by the controllers 51A to 53A.

Here, the present embodiment is described using cooling tower blowdown water generated in the cooling tower 11 (called “blowdown water” hereinafter) as the water to be treated containing at least a salt and silica. This cooling tower blowdown water 12 contains an abundance of Ca²⁺, SO₄²⁻, carbonate ions (CO₃²⁻, HCO₃⁻), and silica, for example. As an example of the characteristics of the blowdown water, the water has a pH of 8, 20 mg/L of Na ions, 5 mg/L of K ions, 50 mg/L of Ca ions, 15 mg/L of Mg ions, 200 mg/L of HCO₃ ions, 200 mg/L of Cl ions, 120 mg/L of SO₄ ions, 5 mg/L of PO₄ ions, and 35 mg/L of SiO₂ ions. Of these, the concentrations of Ca ions, Mg ions, SO₄ ions, and HCO₃ ions are high, and scale (CaSO₄, CaCO₃, or the like) is produced by a reaction in the presence of these ions. In addition, the silica components present in the blowdown water also become adhered components of membrane adhesion depending on concentration rate.

Here, examples of plants that use a water cooling-type cooling tower include power generating facilities (such as an industrial power generating facility for selling power or in-plant power use; power generation consisting of thermal power generation, geothermal power generation, or the like), and plants having a power generating facility or cooling facility. In addition, examples of plants include general chemical plants, iron manufacturing plants, petroleum refining plants, plants for producing machinery, paper, cement, food items, and drugs, plants for mining minerals, oil, and gas, water treatment plants, incineration plants, and regional air conditioning facilities.

Furthermore, in addition to cooling tower blowdown water, examples of the water to be treated containing at least a salt and silica include acid mine drainage (AMD), oil and gas produced water (PW), flue gas desulfurization (FGD) waste water, for example, supply water for boiler plants using ground water, river water, or lake water, for example, as a water source, plant waste water recovery water of semiconductor or automobile factories, for example, and industrial park waste water.

This acid mine drainage (AMD) has a concentration of not greater than approximately 15 mg/L of SiO₂ ions. Oil and gas produced water (PW) has a concentration from 1 to not greater than approximately 200 mg/L of SiO₂ ions. Flue gas desulfurization (FGD) waste water has a concentration from 50 to not greater than 100 mg/L of SiO₂ ions. Supply water for boiler plants using ground water, river water, or lake water, for example, as a water source has a concentration of not greater than 40 mg/L of SiO₂ ions, and not greater than approximately 100 mg/L of total dissolved solids (TDS). Plant waste water recovery water of, for example, semiconductor or automobile factories, or industrial park waste water has not greater than approximately 25 mg/L of SiO₂ ions and from 100 to not greater than approximately 300 mg/L of total dissolved solids (TDS).

In the embodiment illustrated in FIG. 1, the first desalinating apparatus 19A and a second desalinating apparatus 19B include reverse osmosis membrane apparatuses (RO) having reverse osmosis membranes 19a and 19b. A nanofiltration membrane (NF), an electrodialysis (ED), an electro dialysis reversal (EDR), an electro deionization (EDI), an electrostatic desalinating apparatus (CD1), an evaporator, or the like can also be applied appropriately instead of this reverse osmosis membrane apparatus.

Here, in a nanofiltration membrane (NF), an electrodialysis (ED), an electro dialysis reversal (EDR), an electro deionization (EDI), an ion exchanged resin apparatus (IEx), or an electrostatic desalinating apparatus (CDI), scale components (divalent ions, Ca²⁺, Mg²⁺, and the like), are selectively removed, and monovalent ions such as NaCl permeate. By suppressing the ion concentration of concentrated water, it is possible to improve the water recovery rate and conserve energy (for example, a reduction in pump power).

In addition, makeup water for cooling tower cooling water does not have to be purified water as long as the scale components (divalent ions, Ca²⁺, Mg²⁺) are removed, which yields the advantage that a nanofiltration membrane (NF) or the like can be used.

The first crystallizing tank 21A crystallizes the calcium sulfate 20, and removes it from the bottom and separates the calcium sulfate 20 using a dehydrating apparatus (not illustrated).

Also, as in the cooling tower blowdown water reclamation treatment system 10B illustrated in FIG. 2, a hydrocyclone 31 as a calcium sulfate separating means may be provided downstream of the crystallizing tank 21A, such that calcium sulfate 20 and supernatant are separated in the hydrocyclone 31, and the separated calcium sulfate 20 is dehydrated by removing a separated liquid 33 by a dehydrating apparatus 32.

In first scale inhibitor-supplying unit 14A, the scale inhibitor 13 is stored and is supplied under the control of the control unit 51A via the valve V₁.

Here, the scale inhibitor 13 supplied to the blowdown water 12 has functions of inhibiting generation of crystal nuclei in the blowdown water 12, and also adsorbing to the surface of the crystal nuclei (seed crystals or small-diameter scale or the like that has deposited in excess of the saturation concentration) contained in the blowdown water 12, thereby inhibiting crystal growth.

In addition, the scale inhibitor 13 also has a function of dispersing particles in water such as deposited crystals (function of preventing deposition). The scale inhibitor used in the present embodiment is one that prevents deposition of scale containing calcium in the blowdown water 12. This will be called a “calcium scale inhibitor” hereinafter.

The calcium scale inhibitor has functions of inhibiting calcium sulfate or calcium carbonate crystal nucleus generation in the blowdown water and inhibiting crystal growth of calcium sulfate or calcium carbonate by adsorbing to the surface of crystal nuclei of calcium sulfate or calcium carbonate contained in the blowdown water (seed crystals or small-diameter scale or the like that has deposited in excess of the saturated concentration). Alternatively, there are also scale inhibitors having a function of dispersing particles in waste water such as deposited crystals (function of preventing deposition).

Here, examples of calcium scale inhibitors include phosphonic acid-based scale inhibitors, polycarboxylic acid-based scale inhibitors, and mixtures thereof. A specific example is FLOCON 260 (trade name, produced by BWA).

In addition, when Mg²⁺ is contained in the blowdown water 12, a scale inhibitor that prevents the deposition of scale containing magnesium (for example, magnesium hydroxide, magnesium carbonate, and magnesium sulfate) in the blowdown water can be used. This will be called a “magnesium scale inhibitor” hereafter.

Examples of magnesium scale inhibitors include polycarboxylic acid-based scale inhibitors and the like. A specific example is FLOCON 295N (trade name, produced by BWA).

In the present embodiment, the first pH-adjusting unit 16A, which introduces the pH-adjusting agent 15, is connected after the scale inhibitor 13 is supplied to the flow path upstream of the first desalinating apparatus 19A.

In the first pH-adjusting unit 16A, the pH-adjusting agent 15 is stored and is supplied under the control of a control unit 52A via the valve V₂.

An acid (for example, sulfuric acid) or an alkaline agent (for example, calcium hydroxide or sodium hydroxide) is supplied as the pH-adjusting agent 15 from the first pH-adjusting unit 16A.

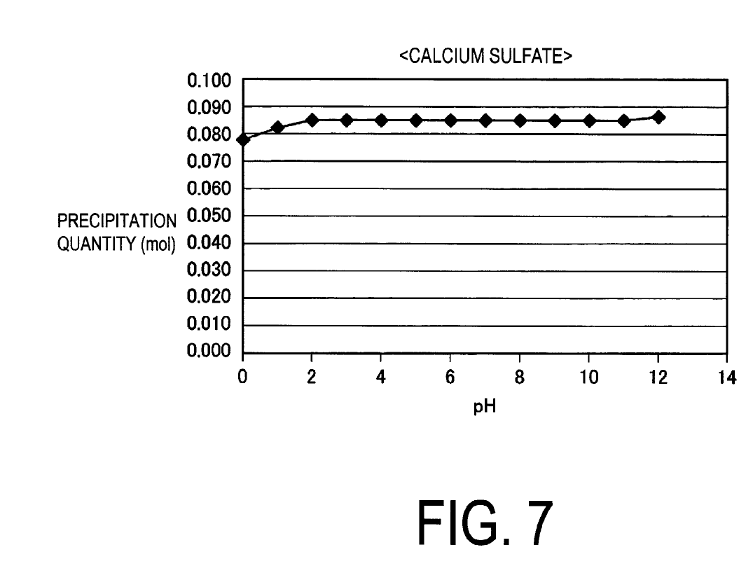

Here, the precipitation behaviors of calcium sulfate, silica, and calcium carbonate in the blowdown water 12 will be described in reference to FIGS. 7 to 9.

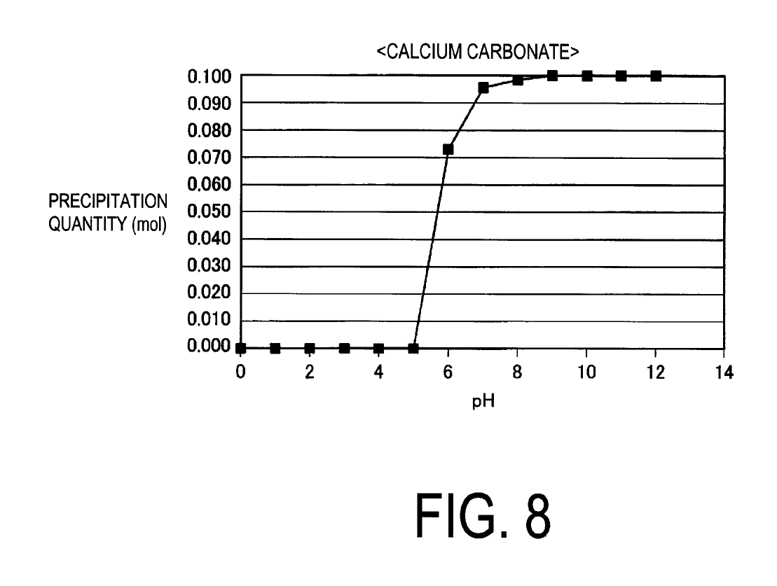

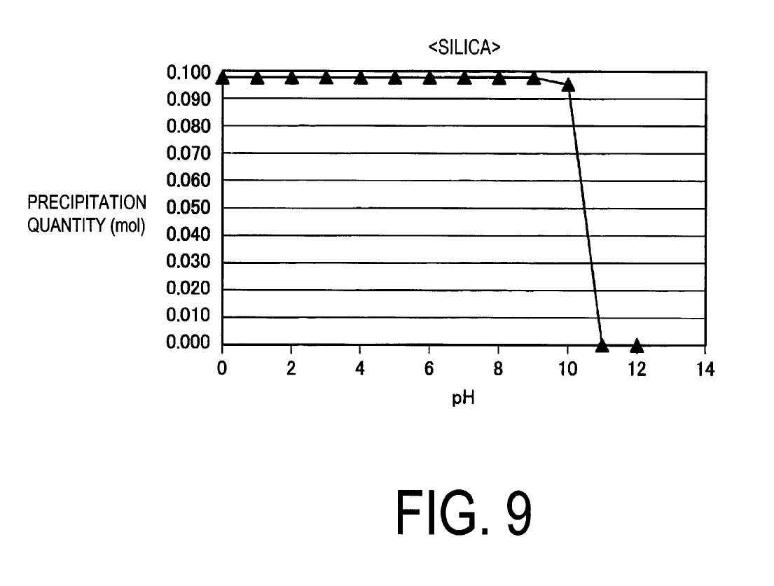

FIG. 7 illustrates simulation results of pH dependence of the precipitation quantity of calcium sulfate. FIG. 8 illustrates simulation results of pH dependence of the precipitation quantity of calcium carbonate. FIG. 9 illustrates simulation results of pH dependence of the precipitation quantity of silica. In these figures, the horizontal axis is pH, and each vertical axis is the respective precipitation quantity (mol) of calcium sulfate, calcium carbonate, and silica. Simulation was performed using simulation software produced by OLI, under conditions where each of the solid components was mixed in water at a concentration of 0.1 mol/L, H₂SO₄ was added as the acid, and Ca(OH)₂ was added as the alkali.

From FIG. 7 it can be understood that calcium sulfate precipitates in the entire range of pH without dependence on pH. However, when a calcium scale inhibitor is added, calcium sulfate precipitation is present in a state of dissolution in the water in the high pH region. From FIG. 8, calcium carbonate precipitates when the pH is over 5. From FIG. 9, silica tends to dissolve in the water when pH is not less than 10.

Thus, the first to third pH adjustments are performed as follows in consideration of the precipitation behaviors of calcium sulfate, silica, and calcium carbonate in the blowdown water 12.

1) First pH Adjustment (pH of not Less than 10)

In the first pH adjustment, the pH of the blowdown water 12 is measured by a pH gauge 55A upstream of the first desalinating apparatus 19A, and is controlled such that the pH value reaches a prescribed pH of not less than 10.

This is because silica dissolves at pH of not less than 10, as illustrated in FIG. 9.

In the first pH adjustment, the quantity of scale inhibitor (calcium scale inhibitor) 13 that inhibits adhesion of calcium sulfate and calcium carbonate as substances that form scale on the reverse osmosis membrane 19a is supplied from the first scale inhibitor-supplying unit 14A.

2) Second pH Adjustment (pH of not Greater than 10)

In the second pH adjustment, the pH of the blowdown water 12 is measured by the pH gauge 55A upstream of the first desalinating apparatus 19A, and is controlled such that the pH value reaches a prescribed pH of not greater than 10.

This is because silica precipitates at pH of not greater than 10, as illustrated in FIG. 9.

In the second pH adjustment, the quantity of scale inhibitor 13 that inhibits adhesion of calcium sulfate, calcium carbonate and silica as substances that form scale on the reverse osmosis membrane 19a is supplied from the first scale inhibitor-supplying unit 14A.

Here, as the silica scale inhibitor 13, two types of scale inhibitor are used: calcium scale inhibitor, and an inhibitor that prevents deposition of silica as scale in the water to be treated (called “silica scale inhibitor”). Examples of silica scale inhibitors include polycarboxylic acid-based scale inhibitors and mixtures thereof. A specific example is FLOCON 260 (trade name, produced by BWA).

3) Third pH Adjustment (pH of not Greater than 6.5)

In the third pH adjustment, the pH of the blowdown water 12 is measured by the pH gauge 55A upstream of the first desalinating apparatus 19A, and is controlled such that the pH value reaches a prescribed pH of not greater than 6.5.

This is because calcium carbonate dissolves at pH of not greater than 6.5, as illustrated in FIG. 8.

In the third pH adjustment, the quantity of scale inhibitors (calcium scale inhibitor, silica scale inhibitor) 13 that inhibits adhesion of calcium sulfate and silica as substances that form scale on the reverse osmosis membrane 19a is supplied from the first scale inhibitor-supplying unit 14A.

Table 1 summarizes the first to third pH adjustments.

TABLE 1

| | pH | | |
|---|---|---|---|
| | Not less than 10 | 10 to 6.5 | Not greater than 6.5 |
| Calcium sulfate | ∘ | ∘ | ∘ |
| Calcium carbonate | ∘ | ∘ | x |
| Silica | x | ∘ | ∘ |

x: Dissolved (scale not inhibited)
∘: Deposited (scale inhibited)

As shown in Table 1, when the pH is not less than 10, the scale inhibitor (calcium scale inhibitor) 13 is supplied to suppress calcium sulfate and calcium carbonate scale (∘ in table), and since silica dissolves, supply of scale inhibitor becomes unnecessary (× in table).

Also, when the pH is from 6.5 to 10, the scale inhibitors (calcium scale inhibitor, silica scale inhibitor) 13 are supplied to suppress calcium sulfate, calcium carbonate, and silica scale (∘ in table).

Furthermore, when the pH is not greater than 6.5, the scale inhibitors (calcium scale inhibitor, silica scale inhibitor) 13 are supplied to suppress calcium sulfate and silica scale (∘ in table), and since calcium carbonate dissolves, it is sufficient to prevent only calcium sulfate scale (× in table), and therefore the amount of calcium scale inhibitor supplied is smaller than the case of the second pH adjustment.

When the silica concentration in the first concentrated water 18A after concentration by the first desalinating apparatus 19A reaches a prescribed concentration or greater, there is a limit to the capacity of the silica scale inhibitor. Thus, when the silica concentration is not greater than the prescribed concentration (for example, 200 mg/L), the first, second, and third pH-adjusting steps are performed, and when the silica concentration is not less than the prescribed concentration (for example, 200 mg/L), it is preferred that the first pH-adjusting step (silica dissolution) be performed.

The first crystallizing unit 23A is constituted of the first crystallizing tank 21A and the first seed crystal-supplying unit 22A. The first seed crystal-supplying unit 22A is connected to the first crystallizing tank 21A. The first seed crystal-supplying unit 22A stores calcium sulfate seed crystals 20a as the seed crystals, and supplies the calcium sulfate seed crystals 20a as the seed crystals to crystallizing tank 21A by the opening and closing of the valve V₃ under the control of the first controller 53A.

Furthermore, as illustrated in the cooling tower blowdown water reclamation treatment system 10B of FIG. 2, an acid adjusting unit 56 which introduces acid 57 may be connected to the first concentrated water 18A supplied to the first crystallizing tank 21A. The acid 57 may be directly introduced into the first crystallizing tank 21A. Here, the acid 57 may be, for example, hydrochloric acid, sulfuric acid, nitric acid, or the like. Sulfuric acid is particularly preferred because it is removed as SO₄²⁻ in the crystallizing step and the quantity of ions that reach the downstream desalinating apparatuses can be reduced.

Next, the treatment steps of the cooling tower blowdown water reclamation treatment system 10A will be described in reference to FIG. 1.

<pH-Adjusting Step>

The controller 52A of the first pH-adjusting unit 16A controls the pH of the blowdown water 12 at the inlet of the first desalinating apparatus 19A to a value at which silica is soluble in the water to be treated.

This treatment step will be described for the case where the “first pH adjustment” described above is applied. Specifically, the pH of the blowdown water 12 supplied to the first desalinating apparatus 19A is adjusted to not less than 10, preferably not less than 10.5, and more preferably not less than 11.

The pH gauge 55A measures the pH of the blowdown water 12 at the inlet of the first desalinating apparatus 19A. The controller 52A adjusts the degree of opening of the valve V₂ and inputs alkali from the tank of the first pH-adjusting unit 16A into the blowdown water 12 such that the value measured by the pH gauge 55A reaches a prescribed pH control value.

### <First Desalinating Step>

In the first desalinating apparatus 19A, the pH-adjusted blowdown water 12 is treated. When the first desalinating apparatus 19A is a reverse osmosis membrane apparatus, the water that passes through the reverse osmosis membrane is recovered as reclaimed water 17A. The ions and scale inhibitor 13 contained in the blowdown water 12 cannot permeate the reverse osmosis membrane 19a. Therefore, the unpermeated side of the reverse osmosis membrane 19a becomes concentrated water 18A having a high ion concentration. When another type of desalinating apparatus such as, for example, an electrostatic desalinating apparatus is used, the blowdown water is similarly separated into treated water and concentrated water 18A having a high ion concentration (first concentrated water).

By means of the first desalinating step, silica is contained in the first concentrated water 18A in the dissolved state in the water to be treated, as illustrated in FIG. 9. Even if calcium sulfate and calcium carbonate in the first concentrated water 18A are concentrated at the saturation concentration or higher, scale generation is suppressed by the calcium scale inhibitor used as the scale inhibitor 13.

When Mg²⁺ is contained in the blowdown water 12, the Mg²⁺ concentration contained in the first concentrated water 18A increases by means of the first desalinating step. However, generation of magnesium hydroxide scale is suppressed by magnesium scale inhibitor used as the scale inhibitor 13.

The first concentrated water 18A is fed toward the first crystallizing unit 23A.

### <First Crystallizing Step>

The first concentrated water 18A discharged from the first desalinating apparatus 19A is stored in the first crystallizing tank 21A of the first crystallizing unit 23A. The first controller 53A of the first seed crystal-supplying unit 22A opens the valve V₃, and adds calcium sulfate seed crystals 20a from the tank of the first seed crystal-supplying unit 22A to the first concentrated water 18A in the first crystallizing tank 21A.

Since the pH of the first concentrated water 18A in the first desalinating apparatus 19A is not less than 10, referring to FIG. 7, calcium sulfate is in the dissolved state in the presence of calcium scale inhibitor. However, when enough seed crystals are present, the calcium sulfate crystallizes with the seed crystals as nuclei even if scale inhibitor is present. In the cooling tower blowdown water reclamation treatment system 10A of FIG. 1, calcium sulfate 20 of which the crystals have grown to a large diameter (for example, particle size not less than 10 μm) settles on the bottom of the first crystallizing tank 21A. The settled calcium sulfate 20 is discharged from the bottom of the first crystallizing tank 21A.

On the other hand, when the pH of the first concentrated water 18A is not less than 10, silica is present in the dissolved state in the first concentrated water 18A in the first crystallizing tank 21A. Even if the silica concentration in the first concentrated water 18A exceeds the saturation concentration, since no seed crystals of silica are present, it precipitates as small suspended matter such as colloidal particles, and does not readily settle.

According to FIG. 8, calcium carbonate tends to precipitate at pH of not less than 10. However, since calcium scale inhibitor is added, deposition of calcium carbonate is suppressed in the first crystallizing tank 21A.

Furthermore, when an upstream settling unit or degassing unit is provided, as in an embodiment to be described later, the calcium carbonate concentration is reduced in advance. As a result, calcium carbonate does not readily crystallize with seed crystals of calcium sulfate 20 as nuclei in the first crystallizing tank 21A.

Furthermore, when calcium sulfate seed crystals 20a are present, calcium sulfate 20 crystallizes without dependence on pH, but the crystallization rate increases as pH decreases.

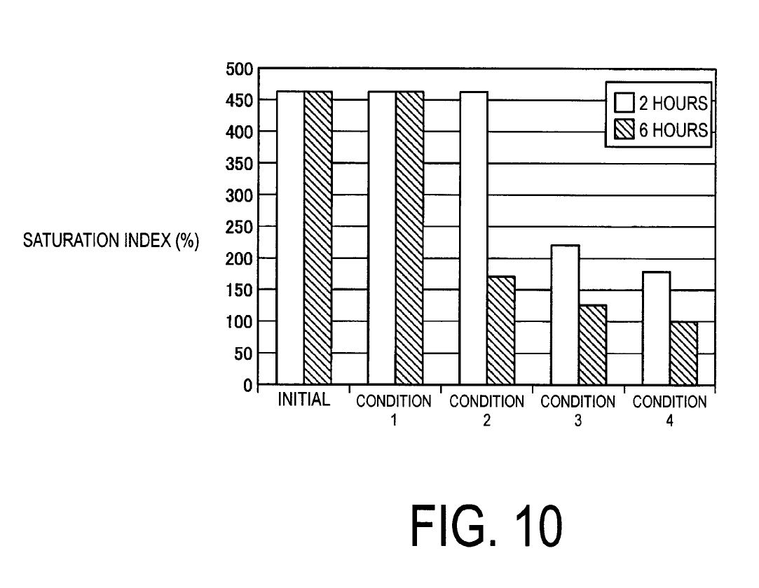

FIG. 10 illustrates the results of calcium sulfate precipitation experiments performed by varying the pH of simulated water in the case where scale inhibitor (FLOCON 260) has been added to simulated water (containing Ca²⁺, SO₄²⁻, Na⁺, Cl⁻) that is supersaturated with calcium sulfate. The experimental conditions are as follows.

Here, the degree of calcium sulfate saturation index of the simulated water (25° C.) was taken as 460%. The added amount of scale inhibitor was taken as 2.1 mg/L. The pH conditions were taken as pH 6.5 (condition 1), pH 5.5 (condition 2), pH 4.0 (condition 3), and pH 3.0 (condition 4). The added amount of seed crystals was taken as 0 g/L.

When 2 hours and 6 hours had elapsed immediately after pH adjustment, the Ca concentration in the simulated water treated under each of the conditions was measured using an atomic absorption spectrometer (AA-7000, produced by Shimadzu Corp.), and the degree of saturation index was calculated. These results are shown in FIG. 10. In the figure, the vertical axis is degree of saturation index (%).

According to FIG. 10, as the pH decreases, the crystallization rate increases even under the condition where no seed crystal is not present. From this fact it can be understood that when seed crystals are present, calcium sulfate crystallizes even under condition 1 (pH 6.5), and the relationship with crystallization rate is such that as pH decreases, the crystallization rate increases, as in FIG. 10.

When the water to be treated contains carbonate ions, carbonate ions are removed from the water to be treated as CO₂ under low pH conditions, as illustrated in Chemical Formula (1). Additionally, as can be understood from FIG. 8, when pH is low, calcium carbonate is in the dissolved state.

[Formula 1]

CO₂+H₂O⇄H₂CO₃⇄HCO₃⁻+H⁺⇄CO₃²⁻+2H⁺ (I)

From the results above, when the first crystallizing step is carried out under low pH conditions, since the content of calcium carbonate and silica is low, calcium sulfate of high purity crystallizes and is recovered from the bottom of the first crystallizing tank 21A.

Additionally, when the first crystallizing step is carried out at low pH, the acid-supplying unit 56 (refer to FIG. 2), which supplies acid 57 as a pH-adjusting agent, is installed inside the first crystallizing tank 21A or in the flow path between the first desalinating apparatus 19A and the first crystallizing tank 21A.

By adjusting the pH to a prescribed value in the step of adding the acid 57 and by adding seed crystal calcium sulfate 20a in the crystallizing step as in the embodiment illustrated in FIG. 2, calcium sulfate 20 of high purity and low water content can be precipitated.

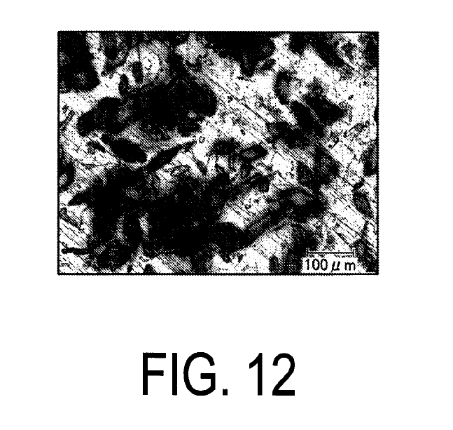

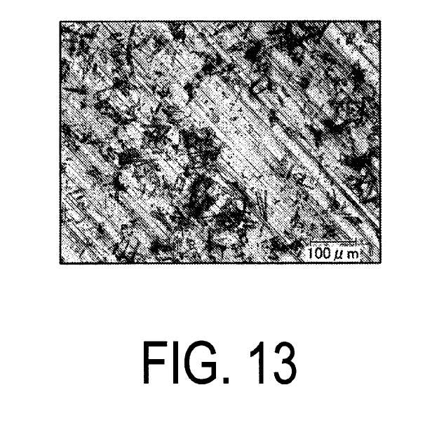

Here, FIGS. 12 and 13 are microscope photographs of calcium sulfate obtained by crystallization. FIG. 12 is the result of observation under the condition where seed crystal calcium sulfate 20a was added as seed crystals. FIG. 13 is the result of observation under the condition where seed crystal calcium sulfate 20a was not added as seed crystals.

As shown in FIG. 12, large calcium sulfate precipitated when seed crystal calcium sulfate 20a was added. In general, as the size of precipitated calcium sulfate increases, water content decreases. When the average particle size is not less than 10 μm, and preferably not less than 20 μm, calcium sulfate having a sufficiently low water content is obtained. Here, the “average particle size” in the present invention is the particle size measured by the method set forth in JIS Z 8825 (laser diffraction method).

From FIGS. 12 and 13, by adjusting the pH to a prescribed value by adding acid 57 and by adding seed crystals in the crystallizing step, calcium sulfate of high purity and low water content can be precipitated. As the added amount of seed crystals increases (as the seed crystal concentration in the first crystallizing tank 21A increases) the crystallization rate of calcium sulfate 20 increases. The added amount of seed crystal calcium sulfate 20a which is the seed crystal is set as appropriate on the basis of the residence time, the concentration of scale inhibitor, and the pH in the first crystallizing tank 21A.

Furthermore, using a hydrocyclone 31 which is a separating unit, calcium sulfate 20 having an average particle size of not less than 10 μm or preferably not less than 20 μm can be separated from the first concentrated water 18A. Some of the calcium sulfate 20 recovered by a dehydrating apparatus 32 adjacent to the hydrocyclone 31 which is a separating unit, pass through a seed crystal recirculating unit (not illustrated) and are stored in the first seed crystal-supplying unit 22A, and some of the recovered calcium sulfate 20 are supplied from the first seed crystal-supplying unit 22A to the first crystallizing tank 21A.

Here, in the first seed crystal-supplying unit 22A, acid treatment is performed on the stored calcium sulfate 20. When scale inhibitor 13 is adhered to the calcium sulfate 20 separated by the dehydrating apparatus 32, the function of the adhered scale inhibitor is reduced by acid treatment. The type of acid used here is not particularly limited, but sulfuric acid is optimal considering the reduction in power used by the second desalinating apparatus 19B.

The calcium sulfate crystallized in the first crystallizing tank 21A has a wide particle size distribution, but since calcium sulfate 20 of not less than 10 μm is separated and recovered from the first concentrated water 18A in the hydrocyclone 31, large calcium sulfate can be used as seed crystals. When large seed crystals are input, a large amount of large calcium sulfate can be crystallized. That is, it is possible to obtain high-quality calcium sulfate with a high recovery rate. Furthermore, large calcium sulfate is easy to separate in the hydrocyclone 31, and the hydrocyclone 31 can be reduced in size, leading to a reduction in power. Furthermore, large calcium sulfate is easy to dehydrate in the dehydrating apparatus 32, and the dehydrating apparatus 32 can be reduced in size, leading to a reduction in power.

On the other hand, a large amount of chemicals (acid and alkali) need to be supplied in order to change the pH in the water treatment process. The use of acids and alkalis leads to an increase in the ion quantity transported to the downstream side of the first crystallizing unit 23A, and causes an increase in the power used by the downstream desalinating apparatus (the second desalinating apparatus 19B in FIG. 1). From the perspective of operating cost, it is advantageous not to vary the pH in the first desalinating step and the first crystallizing step.

The crystallization rate of calcium sulfate depends on the input volume of seed crystals.

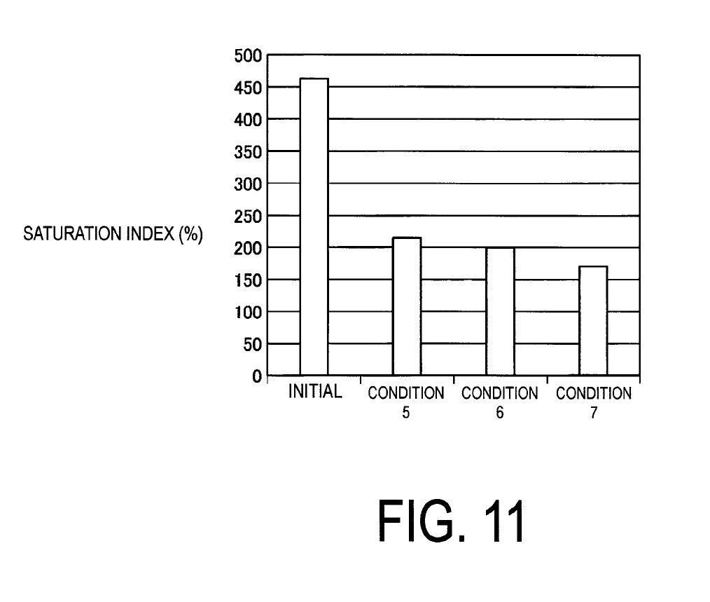

FIG. 11 illustrates the results of calcium sulfate precipitation experiments performed by varying the added quantity of seed crystals in the case where a calcium scale inhibitor (FLOCON 260) has been added to simulated water. The same experimental conditions as in FIG. 10 were used except that the pH was taken as 4.0, like condition 3 of the previous test example, and the following quantities of calcium sulfate as seed crystals were added.

Seed crystal added quantities: 0 g/L (condition 5), 3 g/L (condition 6), 6 g/L (condition 7).

When 2 hours had elapsed immediately after pH adjustment, the Ca concentration in the simulated water treated under each of the conditions was measured by the same method as in FIG. 10. In FIG. 11, the vertical axis is degree of saturation index (%).

From the results of FIG. 11 it can be understood that under condition 5 where no seed crystals are added, the degree of saturation index was 215%, but as the seed crystal concentration increases, the degree of saturation index decreases to 199% (condition 6) and 176% (condition 7), and the calcium sulfate precipitation rate increased. Under high pH conditions, similarly, as the input quantity of seed crystals increases, the calcium sulfate precipitation rate tends to increase.

### <Downstream Desalinating Step>

The first concentrated water 18A from which calcium sulfate 20 was separated is fed to the downstream second desalinating apparatus 19B. Water that passes through the downstream second desalinating apparatus 19B is recovered as reclaimed water 17B. Concentrated water 18B of the second desalinating apparatus 19A is discharged outside the system. When the second desalinating apparatus 19B is installed, after being treated by the first desalinating apparatus 19A, reclaimed water 18B can be recovered from the first concentrated water 18A from which calcium sulfate 20 was removed, and therefore the amount of reclaimed water 17 is the total of the first reclaimed water 17A and the second reclaimed water 17B, and the water recovery rate is improved. Furthermore, to prevent adhesion of scale, scale inhibitor 13 is supplied from a second scale inhibitor-supplying unit 14B, and pH adjustment at that time is controlled by a second pH-adjusting unit 16B. The control method is the same as that use for the first scale inhibitor-supplying unit 14A and the first pH-adjusting unit 16A.

In the cooling tower blowdown water reclamation treatment systems 10A and 10B of the present embodiment, ions are concentrated in the first desalinating apparatus 19A, but calcium sulfate 20 is removed in the first crystallizing unit 23A. For this reason, the first concentrated water 18A that flows into the downstream second desalinating apparatus 19B has a lower ion concentration than before treatment. For this reason, the osmotic pressure in the second desalinating apparatus 19B located downstream becomes lower, and the required power is reduced.

Furthermore, in order to remove carbonate ions in the cooling tower blowdown water 12, a degassing unit 61, which is a carbon dioxide gas separating unit that separates carbon dioxide gas, may be provided upstream of the first scale inhibitor-supplying unit 14A, as in the cooling tower blowdown water reclamation treatment system 10C illustrated in FIG. 3. Specifically, the degassing unit 61 is a degassing tower having filler that disperses carbon dioxide or a separating membrane.

In the cooling tower blowdown water reclamation treatment system 10C of FIG. 3, the blowdown water 12 is adjusted to low pH before flowing into the degassing unit 61. The carbonic acid in the blowdown water 12 is in the equilibrium state shown in Chemical Formula (1) according to its pH.

When the pH is not greater than 6.5, the carbonic acid is present primarily in the state of HCO₃⁻ and CO₂ in the blowdown water 12. Blowdown water 12 that contains CO₂ flows into the degassing unit 61. CO₂ is removed from the blowdown water 12 in the degassing unit 61. The blowdown water 12 of which the carbonate ion concentration has been reduced by this degassing step is then fed to the first scale inhibitor-supplying unit 14A, which supplies scale inhibitor 13. Since the pH is not greater than 6.5 at this time, it is preferred that the pH adjustment described above be the third pH adjustment (pH not greater than 6.5).

In the present embodiment, the obtained reclaimed water 17 (17A, 17B) may be used as makeup water of the cooling tower 11.

In addition to makeup water, if used in a power generating facility, it may be used as cooling water makeup water for another cooling facility, desulfurizing apparatus makeup water, boiler makeup water, recycled water, and the like.

### Embodiment 2

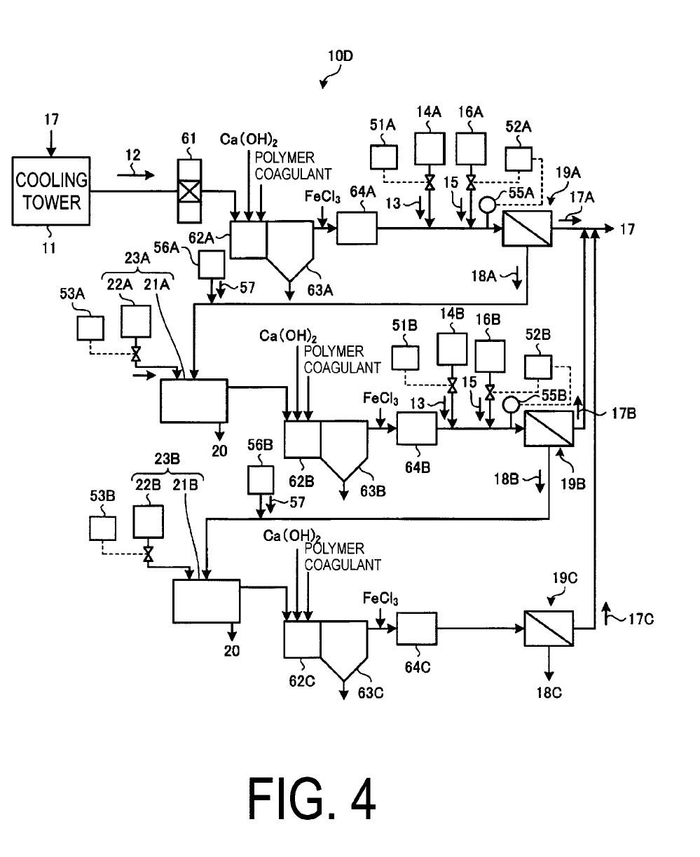

Next, a cooling tower blowdown water reclamation treatment system pertaining to Embodiment 2 will be described. FIG. 4 is a schematic view of a cooling tower blowdown water reclamation treatment system pertaining to the present embodiment. As illustrated in FIG. 4, a cooling tower blowdown water reclamation treatment system 10D is the Embodiment 1 illustrated in FIG. 1 further comprising, as pretreatment, the degassing unit 61, which degasses carbonate ions in the blowdown water 12, a first settling unit 63A having a first adding unit 62A, which settles ions, and a first filtering apparatus 64A. Additionally, on the downstream side of first and second crystallizing units 23A and 23B, the cooling tower blowdown water reclamation treatment system 10D has second and third settling units 63B and 63C having second and third adding units 62B and 62C, which settle ions, and second and third filtering apparatuses 64B and 64C.

Also, as desalination treatment units, three-stage desalination treatment is performed with the first desalinating apparatus 19A, the second desalinating apparatus 19B, and a third desalinating apparatus 19C, in order to increase the produced quantity of reclaimed water 17 (17A, 17B, 17C).

Furthermore, similar to Embodiment 1, the first and second crystallizing units 23A and 23B have the first seed crystal-supplying unit 22A and first controller 53A, and a second seed crystal-supplying unit 22B and second controller 53B respectively. Additionally, on the upstream side of the second desalinating apparatus 19B are provided the second scale inhibitor-supplying unit 14B, which supplies the scale inhibitor 13, and its controller 51B, and a second controller 52B of the second pH-adjusting unit 16B, which supplies a pH-adjusting agent, and a second pH gauge 55B.

### <First Upstream Settling Step>

In the first settling unit 63A, Ca²⁺ and carbonate ions are crudely removed in advance as calcium carbonate from the water to be treated.

When the water to be treated contains metal ions other than Ca²⁺, metal ions that form hydroxides with low solubility in water are crudely removed in advance as metal hydroxides from the water to be treated in the first settling unit 63A.

Ca(OH)₂ and anionic polymer coagulant (trade name Hishifloc H305, produced by Mitsubishi Heavy Industries Mechatronics Systems, Ltd.) are put in the water to be treated in the first settling unit 63A, and the pH in the first settling unit 63A is controlled to a value from 4 to 12, and preferably from 8.5 to 12.

As illustrated in FIG. 8, the solubility of calcium carbonate is low in this pH range. When the calcium carbonate becomes supersaturated, it precipitates and settles on the bottom of the first settling unit 63A.

The solubility of metal hydroxides depends on pH. The solubility of metal ions in water increases as pH becomes more acidic. In the pH region mentioned above, the solubility of many metal hydroxides is low. In the pH region mentioned above, metal hydroxides having low solubility in water precipitate in the first settling unit 63A and settle on the bottom thereof.

The settled calcium carbonate and metal hydroxides are discharged from the bottom of the first settling unit 63A.

Because Mg²⁺ forms a salt that is hardly soluble in water, it is a component that readily deposits as scale. Mg(OH)₂ precipitates at pH of not less than 10.

When treating water containing Mg²⁺ in the reclamation treatment system of the present embodiment, the pH of the water to be treated in the first settling unit 63A is adjusted to a pH at which magnesium compounds (primarily magnesium hydroxide) precipitate. Specifically, the pH of the blowdown water 12 is adjusted to not less than 10. By so doing, magnesium compounds precipitate from the blowdown water 12 and settle on the bottom of the first settling unit 63A, and are removed. As a result, Mg²⁺ in the blowdown water 12 is crudely removed, and the Mg²⁺ concentration decreases.

In the above case, the blowdown water 12 after being discharged from the first settling unit 63A is preferably adjusted to a pH at which the above-mentioned magnesium compounds are soluble. Specifically, when the settled pH is, for example, 10.5, the pH is reduced by approximately 0.1 to 0.5 and adjusted to not less than 10. By so doing, the magnesium compounds go into the dissolved state, and scale generation can be prevented in the downstream apparatuses and steps, especially the first desalinating apparatus 19A and the first desalinating step.

When multiple stages of the first settling unit 63A are provided, Mg²⁺ in the water to be treated can be reliably removed and the Mg²⁺ concentration in the water to be treated fed downstream can be reduced.

The supernatant in the first settling unit 63A, which is the water to be treated, is discharged from the settling tank. FeCl₃ is added to the blowdown water 12, and solids such as calcium carbonate and metal hydroxides in the supernatant flocculate with Fe(OH)₃.

The blowdown water 12 is fed to the first filtering apparatus 64A. The solids flocculated by Fe(OH)₃ are removed by the first filtering apparatus 64A.

In the present embodiment, because the carbonate ions and calcium carbonate in the blowdown water 12 are removed, the supplied amount of scale inhibitor 13 which corresponds to the amount of removed carbonate ions and calcium carbonate can be proportionately reduced compared to Embodiment 1.

Furthermore, in cases where the Ca ion concentration in the blowdown water 12 is high, an ion exchange apparatus (not illustrated) may be provided upstream of the first pH-adjusting unit 16A and the first scale inhibitor-supplying unit 14A located the most upstream, and downstream of the first filtering apparatus 64A. The ion exchange apparatus is, for example, an ion exchange resin tower or an ion exchange membrane apparatus.

Furthermore, in the present embodiment, a settling step is further provided downstream of the first crystallizing unit 23A.

### <First Settling Step>

The first concentrated water 18A, which is the supernatant of the first crystallizing unit 23A, is fed to the second settling unit 63B. In the second settling unit 63B, Ca(OH)₂ and anionic polymer coagulant (Hishifloc H305) are input in the first concentrated water 18A after the crystallizing step, and the pH in the second settling unit 63B is controlled to a value from 4 to 12, and preferably from 8.5 to 12. In the second settling unit 63B, calcium carbonate and metal hydroxides settle and are removed from the first concentrated water 18A. Settled calcium carbonate and metal hydroxides having low solubility in water are discharged from the bottom of the second settling unit 63B.

The first concentrated water 18A, which is the supernatant in the second settling unit 63B, is discharged from the tank. FeCl₃ is added to the discharged first concentrated water 18A, and in the first concentrated water 18A, solids such as calcium carbonate and metal hydroxides in the water to be treated flocculate with Fe(OH)₃.

The water to be treated is fed to the second filtering apparatus 64B. The solids flocculated by Fe(OH)₃ are removed by the second filtering apparatus 64B.

Silica in the first concentrated water 18A, which is the supernatant of the first crystallizing unit 23A, may be removed from the first concentrated water 18A in the first settling step, or may be fed downstream without being removed.

Whether or not to remove silica in the first settling step is determined depending on the properties of the water to be treated and the first concentrated water 18A.

When silica is not removed, the first settling step is performed without recirculating the silica precipitate or supplying a silica precipitation aid in the second settling unit 63B. In this case, silica is separated from reclaimed water 17B and 17C in desalinating apparatuses (the second desalinating apparatus 19B and a third desalinating apparatus 19C) located downstream.

When removing silica, silica precipitate is recirculated and/or a silica precipitation aid is supplied from a supply unit (not illustrated) in the first concentrated water 18A in the second settling unit 63B.

The silica seed crystals are, for example, silica gel, and the silica precipitation aid is, for example, magnesium sulfate. When removing silica, the first concentrated water 18A in the second settling unit 63B is preferably adjusted to a pH from 8 to 10. When recirculation of silica precipitate is employed, silica precipitates using recirculation of deposited matter as nuclei. When MgSO₄ is employed as a silica precipitation aid, magnesium silicate precipitates. The deposited silica or magnesium silicate settles on the bottom of the second settling unit 63B, and is discharged therefrom.

In cases where the blowdown water contains Mg²⁺, the Mg²⁺ and silica in the first concentrated water 18A react and precipitate in the first settling step. The step of removing silica and Mg²⁺ differs depending on the balance of the content of Mg²⁺ and the content of silica in the first concentrated water 18A in the second settling unit 63B.

When the Mg²⁺ concentration is low relative to the silica content in the first concentrated water 18A in the first settling step, Mg²⁺ is consumed in precipitation with silica. To remove excess silica not consumed in precipitation with Mg²⁺, magnesium sulfate is supplied as a silica precipitation aid. The supplied amount of silica precipitation aid is proportionate to the amount of excess silica consumed depending on the content of silica and the content of Mg²⁺ in the first settling step.

When the Mg²⁺ concentration is high relative to the silica content in the first concentrated water 18A in the first settling step, Mg²⁺ remains after precipitation of Mg²⁺ with silica. When the first concentrated water 18A is discharged from the second settling unit 63B while the remaining Mg²⁺ concentration is high, there is risk that scale containing Mg will precipitate in the desalinating apparatuses of subsequent stages (in FIG. 4, the second desalinating apparatus 19B, and, in the case of the third settling unit 63C farthest downstream, the third desalinating apparatus 19C).

Then, the first concentrated water 18A in the first crystallizing tank 21A is adjusted to a value at which magnesium compounds (primarily magnesium hydroxide) can precipitate. By so doing, magnesium compounds settle in the first crystallizing tank 21A, and the Mg²⁺ concentration in the first crystallizing tank 21A is reduced. Additionally, after the first settling step, the first concentrated water 18A discharged from the second settling unit 63B is adjusted to a pH at which magnesium compounds are soluble. Specifically, the pH of the first concentrated water 18A is adjusted to not less than 10, preferably not less than 10.5, and more preferably not less than 11. By so doing, deposition of scale containing Mg in the desalinating apparatuses can be suppressed.

When treatment is carried out in multiple stages, the first concentrated water 18A that passed through the second filtering apparatus 64B of the second settling unit 63B flows into the water treatment unit of the next stage. In the water treatment unit of the next stage, the first scale inhibitor supplying step through the first settling step described above are carried out.

### <Crystallizing Step>

The crystallizing step is carried out in the same manner as in Embodiment 1.

At this time, in the first crystallizing step, the first controller 53A stores the pH range in which the scale inhibiting function of the calcium scale inhibitor is reduced. Specifically, the pH range in which the scale inhibiting function of the calcium scale inhibitor is reduced is not greater than 6.0, preferably not greater than 5.5, and more preferably not greater than 4.0.

The first controller 53A compares the measured value of the pH measuring unit and the pH range. When the measured value is within that pH range, the first controller 53A reduces the degree of opening of the valve V₃ to reduce the supplied amount of calcium sulfate seed crystals 20a. When the measured value is higher than that pH range, the first controller 53A increases the degree of opening of the valve V₃ to increase the supplied amount of calcium sulfate seed crystals.

Calcium sulfate precipitates if seed crystals are present, but when the calcium scale inhibitor functions, the crystallization rate decreases. For this reason, increasing the amount of seed crystals promotes crystallization. On the other hand, when the function of the calcium scale inhibitor has decreased, a sufficient crystallization rate is obtained even if there are few seed crystals.

When the supplied amount of seed crystals is adjusted according to pH in this manner, it is possible to reduce the used amount of seed crystals.

In the present embodiment, seed crystals may be intermittently supplied by periodically measuring pH during continuous operation. Alternatively, for example, the change in pH over time may be determined during trial operation of the system, and the supplied amount of seed crystals may be increased or decreased on the basis of that determined change over time.

This crystallizing step may be controlled in the same manner in the second crystallizing unit 23B as well.

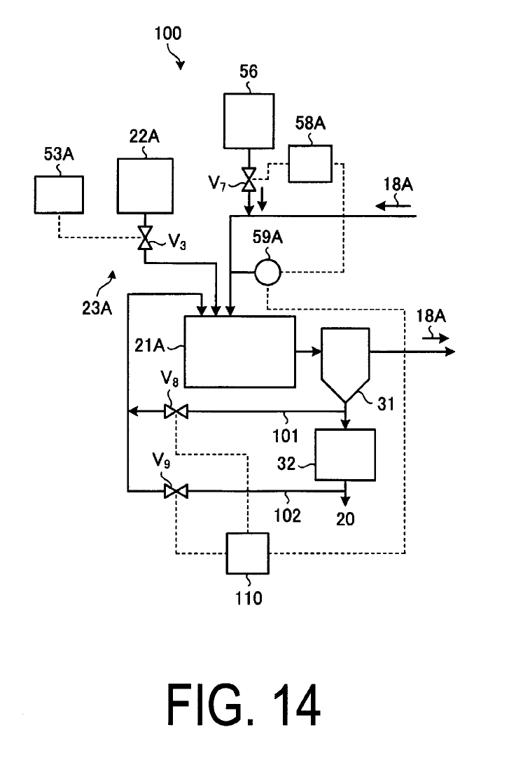

The structure by which the supplied amount of seed crystals to the first crystallizing tank 21A is controlled will be described using FIG. 14. FIG. 14 is a schematic view of another cooling tower blowdown water reclamation treatment system. In FIG. 14, a first recirculating line 101 is installed, which transports some of the calcium sulfate 20 that settled on the bottom of the hydrocyclone 31, which is the first separating unit, such that it is directly supplied to the first crystallizing tank 21A. Additionally, a second recirculating line 102 is installed, which transports some of the calcium sulfate 20 after dehydration in the dehydrating apparatus 32, such that it is directly supplied to the first crystallizing tank 21A. A valve V₈ is installed in the first recirculating line 101, and a valve V₉ is installed in the second recirculating line 102. Furthermore, the embodiment may be configured such that either one of the first recirculating line 101 or second recirculating line 102 is installed. Under the control of a controller 58A, a valve V₇ is opened and closed to supply acid 57 from the acid-supplying unit 56 to the first concentrated water 18A. Also, a controller 110 is connected to a first pH measuring unit 59A, the valve V₈, and the valve V₉.

Control of the supplied amount of seed crystals according to the present embodiment is carried out by the following steps. An example in which the supplied amount of seed crystals is constantly controlled during continuous operation will be described below.

The first pH measuring unit 59A measures the pH of the first concentrated water 18A in the first crystallizing tank 21A. The measured pH value is transmitted to the controller 110.

The controller 110 stores the pH range in which the scale inhibiting function of the calcium scale inhibitor is reduced. The controller 110 compares the measured value of the first pH measuring unit 59A and the pH range, and adjusts the degrees of opening of the valve V₈ and the valve V₉.

In the present embodiment, a seed crystal concentration measuring unit (not illustrated), which measures the calcium sulfate seed crystal concentration in the first concentrated water 18A in the first crystallizing tank 21A, may also be installed in the first crystallizing tank 21A. The seed crystal concentration measuring unit measures the seed crystal concentration in the first crystallizing tank 21A. The measured concentration value is transmitted to the first controller 53A or the controller 110. The first controller 53A or the controller 110 stores the threshold value of seed crystal concentration, and when the seed crystal concentration is not greater than the threshold, it increases the supplied amount of seed crystals.

Furthermore, as a modified example of the present embodiment, a first concentration measuring unit (not illustrated) is installed upstream of the second settling unit 63B and downstream of the first crystallizing tank 21A. In cases where the hydrocyclone 31 of the first separating unit is provided, the first concentration measuring unit is preferably installed downstream of the hydrocyclone 31, but it may also be upstream of the hydrocyclone 31. The first concentration measuring unit is connected to the first controller 53A or the controller 110.

In the case of the second crystallizing unit 23B, a second concentration measuring unit having a similar configuration is installed instead of the first concentration measuring unit.

The first concentration measuring unit measures one or both of the calcium ion concentration and the sulfate ion concentration in the first concentrated water discharged from the first crystallizing tank 21A. The measured concentration value is transmitted to the first controller 53A or the controller 110.

The calcium ion concentration and sulfate ion concentration measured by the first concentration measuring unit depends on the crystallization rate in the first crystallizing tank 21A. With the same residence time, the crystallization rate increases as the calcium ion concentration and sulfate ion concentration decrease.

The first controller 53A and the controller 110 store the threshold values of one or both of calcium ion concentration and sulfate ion concentration.

When one or both of the calcium ion concentration and sulfate ion concentration measured by the first concentration measuring unit is not less than the threshold, the first controller 53A increases the degree of opening of the valve V₃ to increase the supplied amount of seed crystals. When one or both of the calcium ion concentration and sulfate ion concentration measured by the first concentration measuring unit is less than the threshold, the first controller 53A decreases the degree of opening of the valve V₃ to decrease the supplied amount of seed crystals.

When one or both of the calcium ion concentration and sulfate ion concentration measured by the first concentration measuring unit is not less than the threshold, the controller 110 increases the degrees of opening of the valve V₈ and the valve V₉ to increase the supplied amount of seed crystals. When one or both of the calcium ion concentration and sulfate ion concentration measured by the first concentration measuring unit is less than the threshold, the first controller 53A decreases the degrees of opening of the valve V₈ and the valve V₉ to decrease the supplied amount of seed crystals.

The supplied amount of seed crystals is controlled by the same steps as above for the second crystallizing unit 23B as well.

When the supplied amount of seed crystals is controlled depending on one or both of the calcium ion concentration and sulfate ion concentration after the crystallizing step in this manner, the used amount of seed crystals can be reduced.

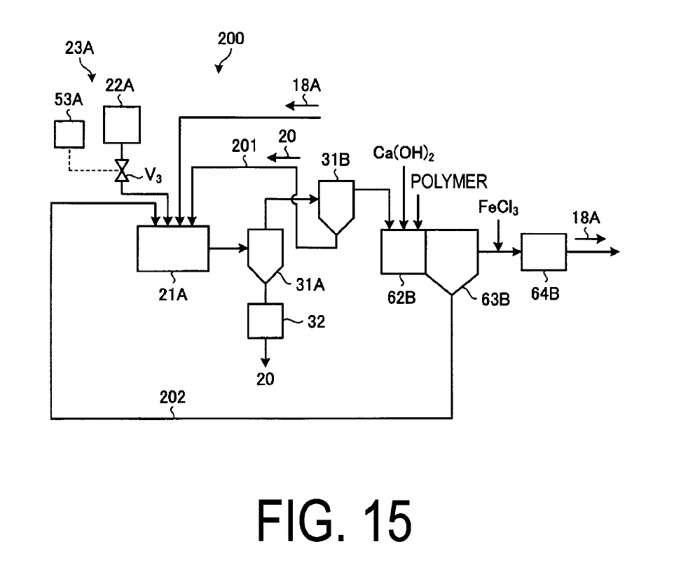

Next, another embodiment of separation of calcium sulfate on the downstream side of the first crystallizing step will be described using FIG. 15. FIG. 15 is a schematic view of another cooling tower blowdown water reclamation treatment system. As illustrated in FIG. 15, a plurality of classifiers (for example, hydrocyclones 31A and 31B) are provided in the direction of passage of the first concentrated water 18A to one first crystallizing unit 23A. In FIG. 15, two classifiers, the first and second classifiers 31A and 31B, are installed. The first classifier 31A located farthest upstream and the second classifier 31B located downstream differ in the size of calcium sulfate 20 that it separates. In the present embodiment, the calcium sulfate 20 separated by the second classifier 31B is smaller than the calcium sulfate separated by the first classifier 31A. For example, the first classifier 31A is a classifier that separates particles of average particle size not less than 10 μm, and the second classifier 31B is a classifier that separates particles of average particle size not less than 5 μm.

When three or more first classifiers are installed, they are designed such that the size of the calcium sulfate separated by each classifier decreases in order from the upstream side to the downstream side. The number of first classifiers installed in the direction of passage of the first concentrated water 18A and the particle sizes of the solids that can be separated by each of the classifiers are set as appropriate in consideration of the water recovery rate, calcium sulfate recovery rate, treatment costs, and the like.

In the reclamation treatment system 200 illustrated in FIG. 15, the following treatment is carried out in the first separation step.

In the first classifier 31A located farthest upstream, calcium sulfate 20 of average particle size not less than 10 μm are classified and settle on the bottom of the first classifier 31A. The settled calcium sulfate 20 is discharged from the first classifier 31A and fed to the dehydrating apparatus 32. The supernatant of the first classifier 31A is fed to the second classifier 31B downstream. This supernatant contains primarily particles less than 10 μm in size (calcium sulfate, calcium carbonate, silica, and the like).

In the second classifier 31B located downstream, calcium sulfate 20 of average particle size not less than 5 μm are classified and settle on the bottom of the second classifier 31B. The supernatant of the first classifier 31B (first concentrated water 18A) is fed to the second settling unit 63B.

The calcium sulfate 20 settled in the second classifier 31B are discharged from the bottom of the second classifier 31B. The discharged calcium sulfate 20 is fed through a solid recirculating line 201 to the first crystallizing tank 21A, and is supplied into the first concentrated water 18A in the first crystallizing tank 21A.

The recirculated calcium sulfate 20 functions as seed crystals in the first crystallizing tank 21A, and crystals of the recirculated calcium sulfate grow by crystallization. Recirculated calcium sulfate that has grown to an average particle size of not less than 10 μm is fed together with the first concentrated water from the first crystallizing tank 21A to the first classifier 31A, and is separated from the first concentrated water 18A by the first classifier 31A, and transported to the dehydrating apparatus 32.

The supernatant of the second classifier 31B contains relatively small particles less than 5 μm in size, for example, having a particle size of approximately 2 to 3 μm. Particularly in the initial period of operation of the reclamation treatment system, calcium sulfate ends up being discharged from the first crystallizing tank 21A before growing to a sufficient size in the first crystallizing tank 21A, and the amount of calcium sulfate that flows into the second settling unit 63B is large. In such cases, the sediment in the second settling unit 63B contains a large quantity of calcium sulfate. Thus, in the present embodiment, a recirculating line 202 that connects the bottom of the second settling unit 63B and the first crystallizing tank 21A may be provided, and the solids containing calcium sulfate 20 that settled on the bottom of the second settling unit 63B can be recirculated to the first crystallizing tank 21A.

According to the present embodiment, as the amount of calcium sulfate recovered in the first separating unit increases, the water content of the recovered calcium sulfate decreases. Use of the water treatment steps and reclamation treatment system of the present embodiment leads to a reduction in the amount of relatively small calcium sulfate that flows out to the downstream side, and therefore, the water recovery rate can be increased and the amount of waste generated by water treatment can be reduced.

### <Downstream Desalinating Step>

The second concentrated water 18B separated in the second desalinating apparatus 19B is treated in the downstream second crystallizing unit 23B in the same manner as in the first crystallizing unit 23A. Then, the second concentrated water 18B that has passed through the third settling unit 63C located downstream of the second crystallizing unit 23B is fed to the third desalinating apparatus 19C. The water that has passed through the third desalinating apparatus 19C is recovered as reclaimed water 17C. The third concentrated water 18C of the third desalinating apparatus 19C is discharged outside the system. When a third desalinating apparatus 19C is installed, reclaimed water 17C can be further recovered from the water that was treated by the second desalinating apparatus 19B, and therefore the water recovery rate of reclaimed water 17 is further improved.

An acid-adjusting unit 56, which is a second pH-adjusting unit that introduces acid 57, can be connected between the second desalinating apparatus 19B and the second crystallizing unit 23B. The acid may be, for example, hydrochloric acid, sulfuric acid, nitric acid, or the like. Sulfuric acid is particularly preferred because SO₄²⁻ is removed as calcium sulfate in the crystallizing step and the quantity of ions that reach the downstream desalinating apparatus can be reduced. The pH is controlled to a low value (preferably not greater than pH 4) by a pH gauge (not illustrated). By so doing, the scale inhibitor 13 can be made ineffective.

Additionally, after the second crystallizing step by the second crystallizing unit 23B, the pH of the second concentrated water 18B may be adjusted such that the calcium scale inhibitor can function. Specifically, the pH is adjusted to not less than 4.0, preferably not less than 5.5, and more preferably not less than 6.0.

By so doing, the scale inhibitor can be made effective. This pH-adjusting step is carried out before the second desalinating step and after the first crystallizing step, or before the downstream third desalinating step and after the second crystallizing step.

In the water reclamation treatment system of the present embodiment, ions are concentrated in the first desalinating apparatus 19A, but calcium sulfate, calcium carbonate, silica, and the like are removed in the first crystallizing unit 23A and the second settling unit 63B. For this reason, the water that flows into the second desalinating apparatus 19B has a lower ion concentration than before treatment. For this reason, the osmotic pressure in the second desalinating apparatus 19B located downstream and in the third desalinating apparatus 19C located downstream becomes lower, and the required power is reduced.

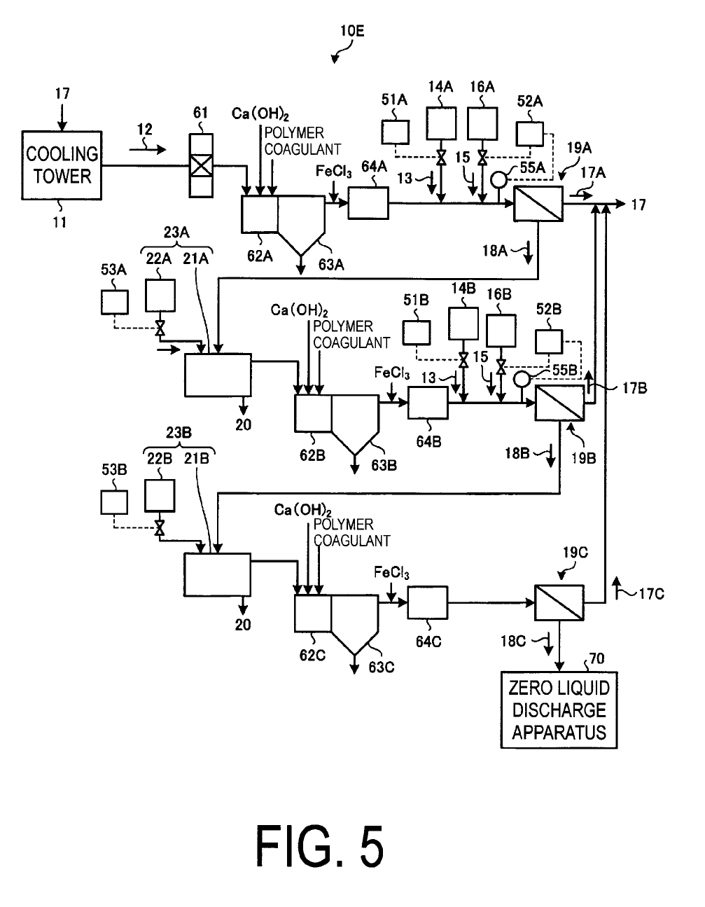

Furthermore, as illustrated in FIG. 5, a zero liquid discharge apparatus 70 may be installed downstream of the third concentrated water 18C side of the downstream third desalinating apparatus 19C.

Examples of the zero liquid discharge apparatus 70 include a spray-drying apparatus that spray-dries the concentrated water with some exhaust gas, drying means that spray-dries it using all of the exhaust gas supplied to an exhaust gas flue, an evaporator or evaporation pond that dries it by evaporation, and the like.

In an evaporator, water is evaporated from the concentrated water, and the ions that had been contained in the concentrated water are precipitated as a solid and recovered as a solid. The water is recovered on the upstream side of the evaporator, and the amount of concentrated water is dramatically reduced, which makes it possible to reduce the size of the evaporator and reduce the energy required for evaporation.

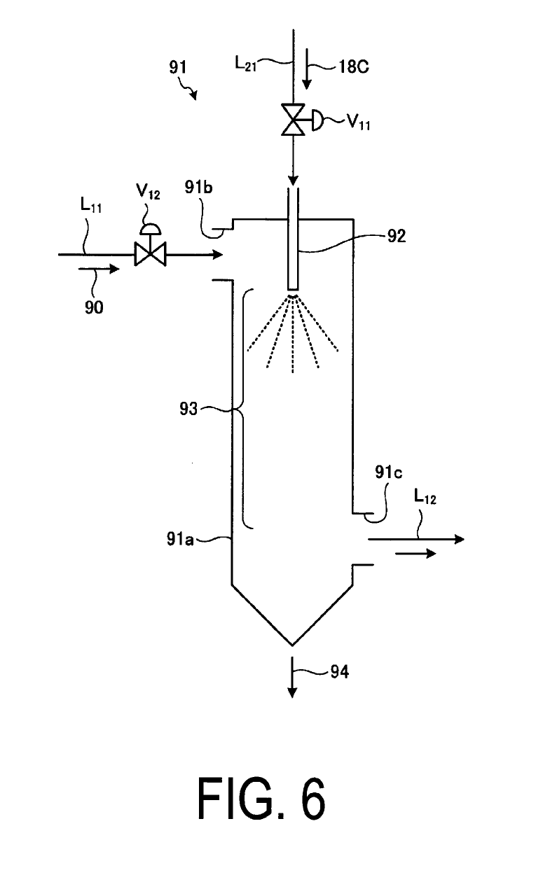

An example of a spray-drying apparatus is illustrated in FIG. 6. FIG. 6 is a schematic view of a spray-drying apparatus. As illustrated in FIG. 6, a spray-drying apparatus 91 of the present embodiment comprises a spray nozzle 92, which sprays third concentrated water 18C introduced into a spray-drying apparatus body 91a from the third desalinating apparatus 19C via an introduction line L₂₁; an introduction inlet 91b, which is provided in the spray-drying apparatus body 91a and introduces some exhaust gas 90 that dries the spray liquid; a drying region 93, which is provided in the spray-drying apparatus body 91a and dries the third concentrated water 18C sprayed by some exhaust gas 90; and a discharge port 91c, which discharges the exhaust gas that contributed to drying. Furthermore, reference numeral 94 denotes solids that were separated in the spray-drying apparatus body 91a, V₁₁ denotes an exhaust gas supply valve, and V₁₂ denotes a concentrated water supply valve.

Here, an example of the balance between the amount of exhaust gas 90 introduced into the spray-drying apparatus 91 and the liquid spray quantity of third concentrated water 18C is described.

When 100 kg/h of third concentrated water 18C per 1000 m³/h of introduced exhaust gas 90 is sprayed from the spray nozzle 92, the gas temperature drops by 200° C.

The moisture concentration in the exhaust gas 90 also increases by 10%. For example, when the moisture concentration before spraying of the introduced exhaust gas 90 is 9%, the moisture concentration after spraying of the exhaust gas that contributed to drying is 19%, increasing approximately 10%.

This 200° C. drop in gas temperature is roughly equivalent to the exhaust gas temperature after passing through an air pre-heater provided in the flue of a boiler.

However, since the amount of exhaust gas 90 bypassed to the spray-drying apparatus 91 is approximately 5% of all the exhaust gas, when the bypassed gas that contributed to drying is returned to the exhaust gas line, it will result in a moisture increase of approximately 10%/20=0.5%.

Furthermore, the temperature of the exhaust gas that passes through the exhaust gas line similarly drops by 200° C. because air is overheated in the air pre-heater and supplied to the boiler, and therefore, there is no temperature differential when it bypasses and returns. Specifically, when the gas temperature on the inlet side of the air pre-heater is 350° C., the gas temperature that dropped due to the gas passing through the air pre-heater and the temperature of the exhaust gas that passed through the branch line L₁₁ and the gas supply line L₁₂ and contributed to drying in the spray-drying apparatus 91 both similarly drop by 200° C., so as to result in roughly the same temperature.

According to the present embodiment, the third concentrated water 18C discharged from the third desalinating apparatus 19C is introduced into the spray-drying apparatus 91 via the spray nozzle 92, and the spray liquid is dried by the heat of the exhaust gas 90. As a result, the third concentrated water 19C does not require separate treatment by an industrial waste water treatment facility, and zero liquid discharge of the blowdown water 12 generated in the cooling tower 11 of a plant can be realized.

### REFERENCE SIGNS LIST

10A to 10E: Cooling tower blowdown water reclamation treatment systems
11: Cooling tower
12: Cooling tower blowdown water (blowdown water)
13: Scale inhibitor
14A, 14B: First, second scale inhibitor-supplying units
15: pH-adjusting agent
16A, 16B: First, second pH-adjusting units
17 (17A to 17C): Reclaimed water
18 (18A to 18C): Concentrated water
19A to 19C: First to third desalinating apparatuses
20: Calcium sulfate
21A, 21B: First, second crystallizing tanks
22A, 22B: First, second seed crystal-supplying units
23A, 23B: First, second crystallizing units

1. A water treatment system comprising:
a first scale inhibitor-supplying unit, which supplies a scale inhibitor to water to be treated that contains at least a salt and silica;
a first pH-adjusting unit, which adjusts a pH of the water to be treated to which the scale inhibitor has been supplied using a pH-adjusting agent;
a first desalinating apparatus, which is provided downstream of the first pH-adjusting unit and removes salts in the water to be treated and separates the water into first reclaimed water and first concentrated water; and
a first crystallizing unit including
a first crystallizing tank, which is provided downstream of the first desalinating apparatus and crystallizes calcium sulfate from the first concentrated water, and
a first seed crystal-supplying unit, which supplies seed crystals of calcium sulfate to the first crystallizing tank.

2. A water treatment system comprising:
a first scale inhibitor-supplying unit, which supplies a scale inhibitor to water to be treated that contains at least a salt and silica;
a first pH-adjusting unit, which adjusts a pH of the water to be treated to which the scale inhibitor has been supplied using a pH-adjusting agent;
a first desalinating apparatus, which is provided downstream of the first pH-adjusting unit and removes salts in the water to be treated and separates the water into first reclaimed water and first concentrated water;
a first crystallizing unit, which has a first crystallizing tank, which is provided downstream of the first desalinating apparatus and crystallizes calcium sulfate from the first concentrated water,
and a first seed crystal-supplying unit, which supplies seed crystals of calcium sulfate to the first crystallizing tank;
a first separating unit, which is provided downstream of the first crystallizing unit and separates calcium sulfate in the first concentrated water;
a second scale inhibitor-supplying unit, which supplies a scale inhibitor to the first concentrated water from which calcium sulfate has been separated;
a second pH-adjusting unit, which adjusts a pH of the first concentrated water to which the scale inhibitor has been supplied; and
a second desalinating apparatus, which is provided downstream of the second pH-adjusting unit and removes salts in the first concentrated water and separates the water into second reclaimed water and second concentrated water.

3. The water treatment system according to claim 2, further comprising:
a second crystallizing unit, which has a second crystallizing tank, which is provided downstream of the second desalinating apparatus and crystallizes calcium sulfate from the second concentrated water,
and a second seed crystal-supplying unit, which supplies seed crystals of calcium sulfate to a second crystallizing tank.

4. The water treatment system according to claim 2, further comprising:
a second crystallizing unit, which has a second crystallizing tank, which is provided downstream of the second desalinating apparatus and crystallizes calcium sulfate from the second concentrated water,
and a second seed crystal-supplying unit, which supplies seed crystals of calcium sulfate to the second crystallizing tank;
a second separating unit, which is provided downstream of the second crystallizing unit and separates calcium sulfate in the second concentrated water; and
a third desalinating apparatus, which removes salts in the second concentrated water and separates the water into third reclaimed water and third concentrated water.

5. The water treatment system according to claim 1, wherein,
when the pH is adjusted to not less than 10 by the first pH-adjusting unit or second pH-adjusting unit, calcium scale inhibitor which inhibits deposition of scale containing calcium is supplied from the first or second scale inhibitor-supplying unit.

6. The water treatment system according to claim 1, wherein,
when the pH is adjusted to not greater than 10 by the first pH-adjusting unit or second pH-adjusting unit, calcium scale inhibitor which inhibits deposition of scale containing calcium and silica scale inhibitor which inhibits deposition of silica are supplied from the scale inhibitor-supplying unit.

7. The water treatment system according to claim 1, further comprising:
one or both of a settling unit, which decreases a calcium carbonate concentration in the water to be treated, and a carbon dioxide gas separating unit, which separates carbon dioxide gas, that are provided upstream of the first or second scale inhibitor-supplying unit.

8. The water treatment system according to claim 1, wherein,
the reclaimed water is used as makeup water or recycled water of a plant facility.

9. A cooling facility comprising the water treatment system described in claim 1.

10. A power generating facility comprising the cooling facility described in claim 9.

11. A water treatment method comprising the steps of:
a first scale inhibitor-supplying step, in which a scale inhibitor is supplied to water to be treated that contains at least a salt and silica;
a first pH-adjusting step, in which a pH of blowdown water to which the scale inhibitor has been supplied is adjusted using a pH-adjusting agent;
a first desalinating step, which is provided downstream of the first pH-adjusting step and in which salts in the blowdown water are removed and the water is separated into first reclaimed water and first concentrated water;
a first crystallizing step, which is provided downstream of the first desalinating step and in which calcium sulfate is crystallized from the first concentrated water; and
a first seed crystal-supplying step, in which seed crystals of calcium sulfate are supplied to a first crystallizing tank.

12. A water treatment method comprising the steps of:
a first scale inhibitor-supplying step, in which a scale inhibitor is supplied to water to be treated that contains at least a salt and silica;
a first pH-adjusting step, in which a pH of blowdown water to which the scale inhibitor has been supplied is adjusted using a pH-adjusting agent;
a first desalinating step, which is provided downstream of the first pH-adjusting step and in which salts in the blowdown water are removed and the water is separated into first reclaimed water and first concentrated water;
a first crystallizing step, which is provided downstream of the first desalinating step and in which calcium sulfate is crystallized from the first concentrated water and;
a first seed crystal-supplying step, in which seed crystals of calcium sulfate are supplied to a first crystallizing tank;
a first separating step, which is provided downstream of the first crystallizing step and in which calcium sulfate in the first concentrated water is separated;
a second scale inhibitor-supplying step, in which a scale inhibitor is supplied to the first concentrated water from which calcium sulfate has been separated;
a second pH-adjusting step, in which a pH of the first concentrated water to which the scale inhibitor has been supplied is adjusted; and
a second desalinating step, which is provided downstream of the second pH-adjusting step and in which salts in the first concentrated water are removed and the water is separated into second reclaimed water and second concentrated water.

13. The water treatment method according to claim 12, further comprising the steps of:
a second crystallizing step, which is provided downstream of the second desalinating step and in which calcium sulfate is crystallized from the second concentrated water; and
a second seed crystal-supplying step, in which seed crystals of calcium sulfate are supplied to a second crystallizing tank.

14. The water treatment method according to claim 12, further comprising the steps of:
a second crystallizing step, which is provided downstream of the second desalinating step and in which calcium sulfate is crystallized from the second concentrated water;
a second seed crystal-supplying step, in which seed crystals of calcium sulfate are supplied to the second crystallizing tank;
a second separating step, which is provided downstream of the second crystallizing step and in which calcium sulfate in the second concentrated water is separated; and
a third desalinating step in which salts in the second concentrated water are removed and the water is separated into third reclaimed water and third concentrated water.

15. The water treatment method according to claim 11, wherein
when the pH is adjusted to not less than 10 by the first or second pH-adjusting step, calcium scale inhibitor which inhibits deposition of scale containing calcium is supplied in the scale inhibitor-supplying step.

16. The water treatment method according to claim 11, wherein
when the pH is adjusted to not greater than 10 by the first or second pH-adjusting step, calcium scale inhibitor which inhibits deposition of scale containing calcium and silica scale inhibitor which inhibits deposition of silica are supplied in the scale inhibitor-supplying step.

17. The water treatment method according to claim 11, further comprising:
one or both of a settling step, in which a calcium carbonate concentration in the blowdown water is decreased, and a carbon dioxide gas separating step, in which carbon dioxide gas is separated, provided upstream of the first or second scale inhibitor-supplying step.

18. The water treatment method according to claim 11, wherein
the reclaimed water is used as makeup water or recycled water of a plant facility.
